(19) United States
(12) Patent Application Publication
(10) Pub. No.: US 2025/0178965 A1
(43) Pub. Date: Jun. 5, 2025

(54) ALKALI-ACTIVATED SLAG CONCRETE

(71) Applicant: National Pingtung University of Science and Technology, Pingtung County (TW)

(72) Inventors: Chia-Jung TSAI, Pingtung County (TW); Bo-Wei WU, Pingtung County (TW)

(73) Assignee: National Pingtung University of Science and Technology, Pingtung County (TW)

(21) Appl. No.: 18/961,943

(22) Filed: Nov. 27, 2024

(30) Foreign Application Priority Data
Nov. 30, 2023 (TW) 112146585

(51) Int. Cl. C04B 28/26; C04B 18/14; C04B 22/06

(52) U.S. Cl. CPC C04B 28/26; C04B 18/14; C04B 22/062

(57) ABSTRACT

An alkali-activated slag concrete includes a cementitious component, sodium hydroxide, and an alkaline activator. The cementitious component includes a solid material. The solid material includes a water-quenched slag powder and a foundry sand. The water-quenched slag powder includes silica. The foundry sand includes silica, a first sodium silicate, and sodium carbonate. The alkaline activator is formed from a reaction of the sodium hydroxide with the first sodium silicate. Based on 100 wt % of the cementitious component, the water-quenched slag powder is present in an amount ranging from 20 wt % to 30 wt %, and the foundry sand is present in an amount ranging from 65 wt % to 80 wt %. Based on a total amount of the water-quenched slag powder as 100 parts by weight, the sodium hydroxide is present in an amount ranging from 2 parts by weight to 6 parts by weight.

### CROSS-REFERENCE TO RELATED APPLICATION

This application claims priority to Taiwanese Invention Patent Application No. 112146585, filed on Nov. 30, 2023, the entire disclosure of which is incorporated by reference herein.

### FIELD

The disclosure relates to a concrete, and more particularly to an alkali-activated slag concrete.

### BACKGROUND

CN 111662046 A discloses a solid waste-based inorganic artificial stone plate including a solid waste-based material present in an amount ranging from 46 parts by weight to 66 parts by weight, a quartz sand present in an amount ranging from 90 parts by weight to 165 parts by weight, an activator present in an amount ranging from 4 parts by weight to 12 parts by weight, water present in an amount ranging from 7 parts by weight to 16 parts by weight, a water-reducing agent present in an amount ranging from 0 part by weight to 2 parts by weight, and an inorganic pigment present in an amount ranging from 0 part by weight to 10 parts by weight. The activator has a modulus (also known as alkaline modulus ratio, which refers to a molar ratio of SiO₂ to Na₂O) ranging from 2.2 to 2.4. The solid waste-based material may be selected from the group consisting of a blast furnace slag, a pulverized fuel ash, a red mud, a coal gangue, a steel slag, and combinations thereof. The blast furnace slag may be an alkaline water-quenched blast furnace slag. The activator may be selected from the group consisting of sodium hydroxide, sodium silicate, potassium hydroxide, sodium carbonate, potassium silicate, potassium carbonate, and combinations thereof. The solid waste-based inorganic artificial stone plate may be formed by mixing the abovementioned ingredients (the solid waste-based material, the quartz sand, the activator, the water, the water reducing agent, and the inorganic pigment) to obtain a semi-dry-wet mixture, and then subjecting the semi-dry-wet mixture to a heat and mechanical pressurization treatment using a thermo-compression molding equipment, followed by a wet curing treatment conducted in a curing room at room temperature and under normal pressure for 1 day.

By virtue of the abovementioned ingredients with the weight proportions thereof, the solid waste-based inorganic artificial stone plate manufactured by the method provided in CN 111662046 A exhibits a high degree of polymerization, a high density and a high strength, and thus meets the mechanical property requirements of an artificial plate. However, after mixing of the aforesaid ingredients, the semi-dry-wet mixture thus obtained has a poor fluidity, causing inconvenience in operation.

### SUMMARY

Therefore, an object of the disclosure is to provide an alkali-activated slag concrete that can alleviate at least one of the drawbacks of the prior art. The alkali-activated slag concrete includes:
a cementitious component including a solid material and water, the solid material including a water-quenched slag powder and a foundry sand, the water-quenched slag powder including silica, the foundry sand including silica, a first sodium silicate, and sodium carbonate,
sodium hydroxide, and
an alkaline activator formed from a reaction of the sodium hydroxide with the first sodium silicate of the foundry sand, the alkaline activator having an alkaline modulus ratio ranging from 0.6 to 0.9 in decimal form.

Based on 100 wt % of the cementitious component, the water-quenched slag powder is present in an amount ranging from 20 wt % to 30 wt %, and the foundry sand is present in an amount ranging from 65 wt % to 80 wt %.

Based on a total amount of the water-quenched slag powder as 100 parts by weight, the sodium hydroxide is present in an amount ranging from 2 parts by weight to 6 parts by weight.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides an alkali-activated slag concrete, which includes a cementitious component, sodium hydroxide, and an alkaline activator. The cementitious component includes a solid material and water. The solid material includes a water-quenched slag powder and a foundry sand. The water-quenched slag powder includes silica, and the foundry sand includes silica, a first sodium silicate, and sodium carbonate. The alkaline activator is formed from a reaction of the sodium hydroxide with the first sodium silicate of the foundry sand, and has an alkaline modulus ratio ranging from 0.6 to 0.9 in decimal form. In addition, based on 100 wt % of the cementitious component, the water-quenched slag powder is present in an amount ranging from 20 wt % to 30 wt %, and the foundry sand is present in an amount ranging from 65 wt % to 80 wt %. Moreover, based on a total amount of the water-quenched slag powder as 100 parts by weight, the sodium hydroxide is present in an amount ranging from 2 parts by weight to 6 parts by weight.

According to the present disclosure, the water-quenched slag powder serves as a cementitious material, and may be a slag which is produced from a steelmaking process conducted in a steelmaking plant, and which is obtained after a hot-melted blast-furnace slag is cooled using a water spray method, and then granulated, and ground into a fine powder.

According to the present disclosure, the foundry sand serves as an aggregate. In certain embodiments, the foundry sand may be distinguished by the types of additives contained therein such that, the foundry sand may be selected from the group consisting of a green sand, a sodium silicate-bonded sand (SBS), a phenolic resin molding sand, a furan sand, and a ceramic shell molding sand. In some embodiments, the foundry sand may be a waste foundry sand, and the waste foundry sand may be selected from the group consisting of a waste green sand, a waste sodium silicate-bonded sand (WSBS), a waste phenolic resin molding sand, a waste furan sand, and a waste ceramic shell molding sand. In yet some embodiments, the waste foundry sand may be derived from a foundry waste material selected from the group consisting of a mold sand, which has undergone a casting process or needs to be replaced, of a foundry plant, a waste sand mold, and a waste sand core. In other embodiments, the waste phenolic resin molding sand may be selected from the group consisting of a waste beta set resin sand, a waste phenolic resin shell molding sand, and a waste alpha set resin sand. Regarding the waste phenolic resin molding sand, reference may be made to the Waste Foundry Sand Resource Utilization Technical Manual published by the Industrial Development Bureau (now renamed as the Industrial Development Administration), Ministry of Economic Affairs, Taiwan, with Hung-Chi Lin as the chief editor.

According to the present disclosure, the sodium hydroxide and the first sodium silicate of the foundry sand together function as the alkaline activator after reaction, and the alkaline modulus ratio of the alkaline activator is a weight ratio of silica to sodium oxide. In the alkaline activator, the silica is derived from the first sodium silicate of the foundry sand, and the sodium oxide is formed from the reaction of the first sodium silicate of the foundry sand with the sodium hydroxide.

According to the present disclosure, the sodium carbonate of the foundry sand can be used to improve the fluidity of the alkali-activated slag concrete, thereby decreasing setting speed of the alkaline-activated slag concrete and hence prolonging setting time thereof. Moreover, in addition to the sodium carbonate of the foundry sand, by controlling the alkaline modulus ratio of the alkaline activator to range from 0.6 to 0.9 in decimal form, the alkali-activated slag concrete according to the present disclosure is conferred with further improvement in fluidity, thus facilitating operation thereof.

In certain embodiments, the alkaline activator may include the sodium oxide present in an amount ranging from 4 parts by weight to 6 parts by weight based on the total amount of the water-quenched slag powder as 100 parts by weight, thus defining an alkali equivalent (AE) ranging from 4% to 6%.

In certain embodiments, the alkali-activated slag concrete may be free from a pulverized fuel ash, a red mud, a coal gangue, and a steel slag.

In certain embodiments, the alkali-activated slag concrete may further include a second sodium silicate which, together with the first sodium silicate of the foundry sand, reacts with the sodium hydroxide to form the alkaline activator.

In certain embodiments, a weight ratio of the water of the cementitious component to the water-quenched slag powder may range from 0.3 to 0.8 in decimal form.

The disclosure will be further described by way of the following examples. However, it should be understood that the following examples are solely intended for the purpose of illustration and should not be construed as limiting the disclosure in practice.

### Preparation of Alkali-Activated Slag Concrete

### Example 1

First, 18.22 kg of sodium hydroxide, 528 kg of a water-quenched slag powder (including, based on 100 wt % of the water-quenched slag powder, silica (SiO₂) present in an amount of 33.68 wt %, aluminum oxide (Al₂O₃) present in an amount of 15.05 wt %, ferric oxide (Fe₂O₃) present in an amount of 0.93 wt %, calcium oxide (CaO) present in an amount of 41.98 wt %, magnesium oxide (MgO) present in an amount of 6.40 wt %, and sulfur trioxide (SO₃) present in an amount of 0.04 wt %; and having a specific gravity of 2.9, a specific surface area of 553 m²/Kg, and a pozzolanic activity index of 120%), and 1501 kg of a waste sodium silicate (Na₂SiO₃)-bonded sand (serving as a foundry sand; and including Na₂SiO₃ (serving as a first sodium silicate) present in an amount of 3.3 wt % based on 100 wt % of the waste sodium Na₂SiO₃-bonded sand, SiO₂, Al₂O₃, Fe₂O₃, sodium oxide (Na₂O), and sodium carbonate (Na₂CO₃)) were mixed, so as to obtain a solid mixture. Thereafter, the solid mixture was mixed with water, thereby obtaining an alkali-activated slag concrete of Example 1. To be specific, a weight ratio of the water to the water-quenched slag powder was 0.5 in decimal form, and an alkali equivalent of the alkali-activated slag concrete of Example 1 was 4%.

### Examples 2 and 3

The procedures for preparing an alkali-activated slag concrete of each of Examples 2 and 3 were similar to those of Example 1, except that the amounts of sodium hydroxide and the alkaline activator, and the value of alkali equivalent were varied, and a second sodium silicate (Na₂SiO₃) was used (with different amounts in Examples 2 and 3), as shown in Table 1 below. In addition, in each of Examples 2 and 3, the second sodium silicate had a Baume degree of 50.5° Be and included SiO₂ present in an amount of 32.2 wt % and Na₂O present in an amount of 13.18 wt %, based on 100 wt % of the second sodium silicate.

### Preparation of Concrete

### Comparative Example

1 kg of a Portland cement Type I (including, based on 100 wt % of the Portland cement Type I, SiO₂ present in an amount of 20.34 wt %, Al₂O₃ present in an amount of 5.18 wt %, Fe₂O₃ present in an amount of 3.12 wt %, CaO present in an amount of 63.62 wt %, MgO present in an amount of 3.08 wt %, and SO₃ present in an amount of 2.26 wt %; and having a specific gravity of 3.15, and a specific surface area of 362 m²/kg) and 3 kg of a quartz sand (having a specific gravity of 2.45) were mixed, so as to obtain a solid mixture. Subsequently, the solid mixture was mixed with water, thereby obtaining a concrete of Comparative Example.

### Property Evaluation

### <Determination of Setting Time>

Each of the alkali-activated slag concretes of Examples 1 to 3 was subjected to determination of initial setting time as well as final setting time in accordance with the American Society for Testing and Materials (ASTM) C191-21 (Standard Test Methods for Time of Setting of Hydraulic Cement by Vicat Needle). The results were shown in Table 1 below.

### <Determination of Fluidity>

Each of the alkali-activated slag concretes of Examples 1 to 3 was subjected to determination of fluidity in accordance with the ASTM C1019 (Standard Test Method for Sampling and Testing Grout). The results were shown in Table 1 below.

### <Determination of Compressive Strength>

Each of the alkali-activated slag concretes of Examples 1 to 3, and the concrete of Comparative Example was subjected to determination of compressive strength in accordance with the ASTM C109 (Standard Test Method for Compressive Strength of Hydraulic Cement Mortars (Using 2-in. or [50-mm] Cube Specimens)). First, twelve compression test molds each having a cube shape (size: 5 cm×5 cm×5 cm) were prepared. Subsequently, each of the alkali-activated slag concretes of Examples 1 to 3, and the concrete of Comparative Example was poured into three of the compression test molds, and then left to stand until solidification thereof, so as to form three solidified objects, followed by remolding the three solidified objects from a corresponding one of the compression test molds. The twelve solidified objects thus obtained were then divided into three test groups, namely test groups 1 to 3. Each of the test groups 1 to 3 included the solidified objects of Examples 1 to 3 and Comparative Example, respectively. Thereafter, the solidified objects in test group 1 were subjected to a first wet curing process for 7 days, the solidified objects in test group 2 were subjected to a second wet curing process for 14 days, and the solidified objects in test group 3 were subjected to a third wet curing process for 28 days. At the end of each of the first, second, and third wet curing processes, each of the solidified objects in a corresponding test group was taken out, and then surfaces thereof were wiped to be as dry as possible while an interior thereof was kept as humid as possible, followed by placing the solidified object on a stage of a compressive strength testing machine (Gotech Testing Machines Inc.; Model: GT-7001-LC 50) to determine compressive strength under a pressurization rate of 2.5±1 kgf/cm²·sec⁻¹.

The compressive strength of each of the solidified objects of Examples 1 to 3 and Comparative Example after each of the first, second, and third wet curing processes was calculated using the following Equation (1):

$$A = B / C \qquad ( 1 )$$

where A=compressive strength (MPa)
   B=maximum load value (kgf)
   C=actual stressed area (cm²)

TABLE 1

| | | | Example | | | Comparative |
|---|---|---|---|---|---|---|
| | | | 1 | 2 | 3 | Example |
| Solid | Water-quenched | | 528 | 528 | 528 | — |
| material | slag powder | | | | | |
| | Waste sodium | | 1501 | 1501 | 1501 | — |
| | silicate-bonded | | | | | |
| | sand | | | | | |
| Water | | | 264 | 264 | 264 | — |
| Sodium hydroxide | | | 18.22 | 22.77 | 27.32 | — |
| Second sodium silicate | | | 0 | 14.02 | 26.71 | — |
| Alkaline | Silica | | 16.9 | 21.12 | 25.34 | — |
| activator | Sodium oxide | | 21.12 | 26.4 | 31.68 | — |
| Weight ratio of water to | | | 0.5 | 0.5 | 0.5 | — |
| water-quenched slag powder | | | | | | |
| Alkaline modulus ratio | | | 0.8 | 0.8 | 0.8 | — |
| Alkaline equivalent (%) | | | 4 | 5 | 6 | — |
| Property | Com- | Test | 17.56 | 23.20 | 27.25 | 18.37 |
| evaluation | pressive | group 1 | | | | |
| | strength | Test | 25.04 | 27.73 | 38.91 | 24.42 |
| | (MPa) | group 2 | | | | |
| | | Test | 30.91 | 33.38 | 39.95 | 28.88 |
| | | group 3 | | | | |

| | | | | |
|---|---|---|---|---|
| Fluidity (cm) | 21.25 | 25.25 | 22.75 | — |
| Initial setting time | 2.7 | 3.7 | 3.7 | — |
| (hour(s)) | | | | |
| Final setting time | 6 | 6 | 5.33 | — |
| (hour(s)) | | | | |

By virtue of controlling the alkaline modulus ratio of the alkaline activator to range from 0.6 to 0.9 in decimal form, and by using the ingredients of the alkali-activated slag with determined amounts thereof, the alkali-activated slag concrete according to the present disclosure has advantages of high fluidity and long setting time, such that the solidified object formed from such alkali-activated slag concrete has an advantage of high compressive strength.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An alkali-activated slag concrete, comprising:
a cementitious component including a solid material and water, the solid material including a water-quenched slag powder and a foundry sand, the water-quenched slag powder including silica, the foundry sand including silica, a first sodium silicate, and sodium carbonate,
sodium hydroxide, and
an alkaline activator formed from a reaction of the sodium hydroxide with the first sodium silicate of the foundry sand, the alkaline activator having an alkaline modulus ratio ranging from 0.6 to 0.9 in decimal form;
wherein based on 100 wt % of the cementitious component, the water-quenched slag powder is present in an amount ranging from 20 wt % to 30 wt %, and the foundry sand is present in an amount ranging from 65 wt % to 80 wt %, and
wherein based on a total amount of the water-quenched slag powder as 100 parts by weight, the sodium hydroxide is present in an amount ranging from 2 parts by weight to 6 parts by weight.

2. The alkali-activated slag concrete as claimed in claim 1, wherein the alkaline activator includes sodium oxide present in an amount ranging from 4 parts by weight to 6 parts by weight based on the total amount of the water-quenched slag powder as 100 parts by weight.

3. The alkali-activated slag concrete as claimed in claim 1, which is free from a pulverized fuel ash, a red mud, a coal gangue, and a steel slag.

4. The alkali-activated slag concrete as claimed in claim 1, wherein the foundry sand is selected from the group consisting of a green sand, a sodium silicate-bonded sand, a phenolic resin molding sand, a furan sand, and a ceramic shell molding sand.

5. The alkali-activated slag concrete as claimed in claim 1, wherein the foundry sand is a waste foundry sand.

6. The alkali-activated slag concrete as claimed in claim 5, wherein the waste foundry sand is selected from the group consisting of a waste green sand, a waste sodium silicate-bonded sand, a waste phenolic resin molding sand, a waste furan sand, and a waste ceramic shell molding sand.

7. The alkali-activated slag concrete as claimed in claim 1, further comprising a second sodium silicate which, together with the first sodium silicate of the foundry sand, reacts with the sodium hydroxide to form the alkaline activator.
